(19) United States
(12) Patent Application Publication
(10) Pub. No.: US 2023/0325844 A1
(43) Pub. Date: Oct. 12, 2023

(54) TRANSACTION VALIDATION IN THIRD-PARTY COMPUTER SIMULATED ENVIRONMENTS

(71) Applicant: SAP SE, Walldorf (DE)

(72) Inventors: Debashis Banerjee, Bengaluru (IN); Kavitha Krishnan, Bangalore (IN); Shivaprasad KC, Bangalore (IN); Prasanna Kumar Govindappa, Bangalore (IN)

(21) Appl. No.: 17/717,517

(22) Filed: Apr. 11, 2022

(51) Int. Cl. G06Q 20/42; G06Q 20/40

(52) U.S. Cl. CPC G06Q 20/42; G06Q 20/405

(57) ABSTRACT

A method may for procurement in a computer simulated environment may include receiving, from the computer simulated environment and/or a client device interacting with the computer simulated environment, a first message associated with a procurement transaction being conducted in the computer simulated environment. The procurement transaction including a digital asset and/or a physical asset associated with the computer simulated environment. In response to receiving the first message, the procurement transaction may be validated based on one or more applicable procurement policies. Moreover, a second message including the result of validating the procurement transaction may be sent to the computer simulated environment and/or the client device interacting with the computer simulated environment. Related systems and computer program products are also provided.

### FIELD

The present disclosure generally relates to enterprise software applications and more specifically to transaction validation in third-party computer simulated environments.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Data associated with multiple enterprise software applications may be stored in a common database in order to enable a seamless integration between different enterprise software applications. For example, an enterprise resource planning (ERP) application may track resources, such as cash, raw materials, and production capacity, and the status of various commitments such as purchase order and payroll. In the event the enterprise interacts with large and evolving roster of external vendors, the enterprise resource planning (ERP) application may be integrated with a supplier lifecycle management (SLM) application configured to perform one or more of supplier identification, selection and segmentation, onboarding, performance management, information management, risk management, relationship management, and offboarding.

### SUMMARY

Methods, systems, and articles of manufacture, including computer program products, are provided for transaction validation in computer simulated environments. In one aspect, there is provided a system. The system may include at least one data processor and at least one memory. The at least one memory may store instructions that result in operations when executed by the at least one data processor. The operations may include: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

In some variations, one or more of the features disclosed herein including the following features can optionally be included in any feasible combination. The asset may include a digital asset native to the computer simulated environment or a physical asset having a virtual representation within the computer simulated environment.

In some variations, the operations may further include: updating an audit log to include an entry corresponding to the result of validating the procurement transaction.

In some variations, the operations may further include: determining, based at least on the audit log, that application of a procurement policy results in an above- or below-threshold quantity of procurement transactions being rejected; applying a machine learning model trained to parse a plurality of procurement transactions rejected based on the procurement policy and identify at least one common attribute present in the plurality of procurement transactions; and generating a recommendation to modify the procurement policy based on the at least one common attribute.

In some variations, the first message may include an identifier of the asset, an action, and data associated with the action. The action may include one of buy or sell. The data associated with the may action include at least one of a currency and a supplier.

In some variations, the first message may be generated in response to the client device interacting with the computer simulated environment to initiate the procurement transaction.

In some variations, the first message and the second message may each include an application programming interface (API) call.

In some variations, the operations may further include: sending, to the computer simulated environment and/or the client device, a packet including the one or more procurement policies such that another procurement transaction is validated at the computer simulated environment and/or the client device based on the one or more procurement policies cached at the computer simulated environment and/or the client device.

In some variations, the operations may further include: updating the one or more procurement policies cached at the computer simulated environment and/or the client device.

In some variations, the client device comprises an augmented reality (AR) or virtual reality (VR) device.

In another aspect, there is provided a method for transaction validation in computer simulated environments. The method may include: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

In some variations, one or more of the features disclosed herein including the following features can optionally be included in any feasible combination. The asset may include a digital asset native to the computer simulated environment or a physical asset having a virtual representation within the computer simulated environment.

In some variations, the method may further include: updating an audit log to include an entry corresponding to the result of validating the procurement transaction.

In some variations, the method may further include: determining, based at least on the audit log, that application of a procurement policy results in an above- or below-threshold quantity of procurement transactions being rejected; applying a machine learning model trained to parse a plurality of procurement transactions rejected based on the procurement policy and identify at least one common attribute present in the plurality of procurement transactions; and generating a recommendation to modify the procurement policy based on the at least one common attribute.

In some variations, the first message may include an identifier of the asset, an action, and data associated with the action. The action may include one of buy or sell. The data associated with the may action include at least one of a currency and a supplier.

In some variations, the first message may be generated in response to the client device interacting with the computer simulated environment to initiate the procurement transaction.

In some variations, the first message and the second message may each include an application programming interface (API) call.

In some variations, the method may further include: sending, to the computer simulated environment and/or the client device, a packet including the one or more procurement policies such that another procurement transaction is validated at the computer simulated environment and/or the client device based on the one or more procurement policies cached at the computer simulated environment and/or the client device; and updating the one or more procurement policies cached at the computer simulated environment and/or the client device.

In some variations, the client device comprises an augmented reality (AR) or virtual reality (VR) device.

In another aspect, there is provided a computer program product that includes a non-transitory computer readable storage medium. The non-transitory computer-readable storage medium may include program code that causes operations when executed by at least one data processor. The operations may include: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to transaction validation in computer simulated environments, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a system diagram illustrating an example of an enterprise procurement system, in accordance with some example embodiments;

FIG. 1B depicts a schematic diagram illustrating the architecture of an example of an enterprise procurement system, in accordance with some example embodiments;

FIG. 2A depicts a screenshot illustrating an example of a user interface for configuring a procurement policy for assets from a computer simulated environment, in accordance with some example embodiments;

FIG. 2B depicts a screenshot illustrating an example of a user interface displaying line items corresponding to assets from a computer simulated environment, in accordance with some example embodiments;

FIG. 2C depicts a screenshot illustrating an example of a user interface for managing a procurement policy for assets from a computer simulated environment, in accordance with some example embodiments;

FIG. 3A depicts a flowchart illustrating an example of a process for procuring assets from a computer simulated environment, in accordance with some example embodiments;

FIG. 3B depicts a flowchart illustrating another example of a process for procuring assets from a computer simulated environment, in accordance with some example embodiments;

FIG. 3C depicts a flowchart illustrating another example of a process for procuring assets from a computer simulated environment, in accordance with some example embodiments;

FIG. 4 depicts a flowchart illustrating an example of a process for transaction validation in a computer simulated environment, in accordance with some example embodiments;

FIG. 5 depicts a block diagram illustrating an example of a computing system, in accordance with some example embodiments.

When practical, like labels are used to refer to same or similar items in the drawings.

### DETAILED DESCRIPTION

Enterprise software applications may provide a variety of procurement and supply chain management solutions while integrating document management features for the electronic documents (e.g., purchase orders, sales contracts, licensing agreements, and/or the like) that may arise as a part of the process. For example, some enterprise software applications may support the configuration, storage, and deployment of procurement policies, which impose restrictions on the purchase of various assets (e.g., price, budget, currency, quantity, supplier, time, and/or the like). Nevertheless, conventional enterprise software applications are unable to enforce procurement policies against the procurement of assets in computer simulated environments, in particular computer simulated environments controlled by third parties. As such, in some example embodiments, a procurement gateway associated with an enterprise software application may be configured to mediate asset procurement in a computer simulated environment. For instance, the procurement gateway may interface with an application associated with the computer simulated environment (e.g., via an application programming interface (API) and/or the like) to enforce procurement policies in real time by verifying the compliance of various procurement transactions at runtime. Alternatively and/or additionally, the procurement gateway may share and synchronize relevant procurement policies with the computer simulated environment and client devices interacting with the computer simulated environment. Furthermore, the procurement gateway may adapt an existing procurement policy based on whether the procurement policy is accepted or rejected by the computer simulated environment.

As used herein, the term “computer simulated environment” may refer to a virtual world or a network of virtual words (e.g., 3-dimensional virtual worlds) populated by multiple users. Through a personal avatar, each user can explore the virtual world and participate in various activities while interacting with other users in the computer simulated environment. In some cases, the term “computer simulated environment” may be used interchangeably with the term “metaverse,” with the latter referring more specifically to a network of 3-dimensional virtual worlds. Although procurement in the context of a computer simulated environment often entails the purchase of a digital asset native to the computer simulated environment (e.g., non-fungible tokens (NFTs)) using non-traditional currencies (e.g., cryptocurrencies and/or the like), some procurement transactions may also include the use of traditional currencies and/or purchase of physical assets with virtual representations in the computer simulated environment but exist beyond the computer simulated environment. Moreover, some procurement transactions in a computer simulated environment may be facilitated by or conducted entirely through an augmented reality (AR) or virtual reality (VR) device such as a virtual reality headset.

In some example embodiments, digital and physical assets available through a computer simulated environment may be integrated into one or more enterprise software applications such that procurement policies configured through the one or more enterprise software applications may be enforced against purchases of such assets. For example, an asset available through a computer simulated environment may be associated with a special tag identifying the asset as such when the asset appears, for example, as a part of a line item in a catalog and/or a classification system of an enterprise software application (e.g., a procurement application and/or the like). Moreover, the procurement gateway may respond to a procurement transaction conducted in the computer simulated environment via, for example, an augmented reality (AR) or virtual reality (VR) device, by at least evaluating the procurement transaction against one or more applicable procurement policies in real time. Alternatively and/or additionally, the procurement gateway may generate and export (e.g., via an application programming interface (API) and/or the like) a policy packet containing a set of applicable procurement policies in order to share and synchronize procurement policies with the computer simulated environment and/or the client devices interacting with the computer simulated environment.

It should be appreciated that some procurement policies may be specific to assets associated with a computer simulated environment while some procurement policies may be applicable to assets associated with the computer simulated environment as well as assets independent of the computer simulated environment. Moreover, a single policy packet may include multiple procurement policies, each of which imposing one or more restrictions on, for example, the price, budget, currency, quantity, supplier, and time of procurement transactions.

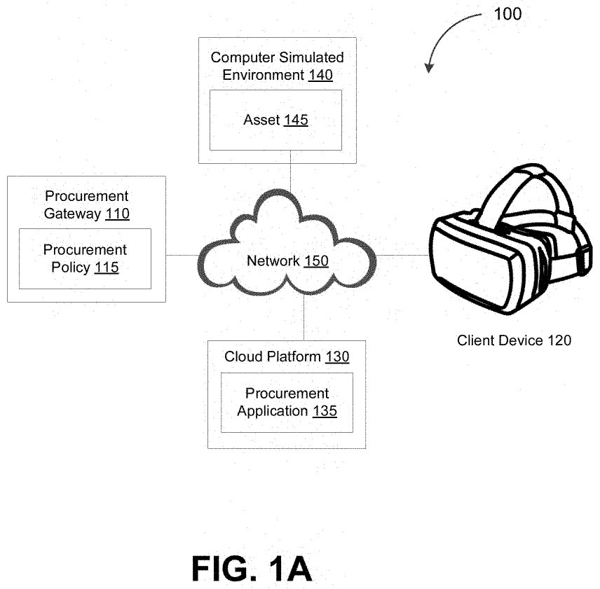

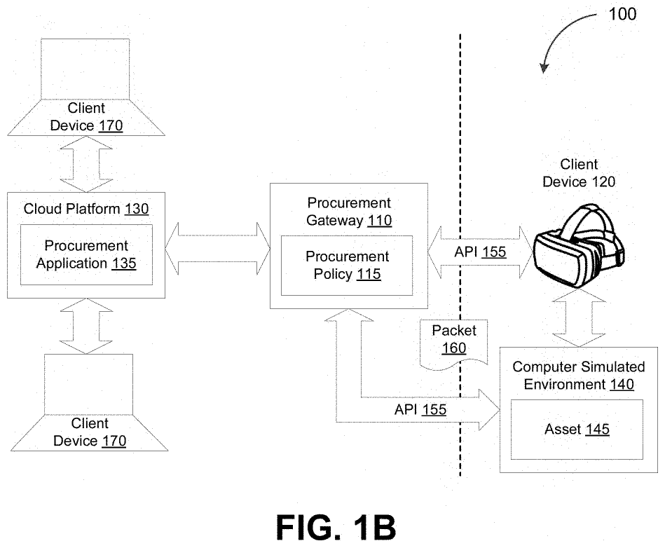

FIG. 1A depicts a system diagram illustrating an example of a procurement system 100, in accordance with some example embodiments. Referring to FIG. 1A, the procurement system 100 may include a procurement gateway 110, a client device 120, a cloud platform 130 hosting one or more enterprise software applications including a procurement application 135, and a computer simulated environment 140. As shown in FIG. 1A, the procurement gateway 110, the client device 120, the cloud platform 130, and the computer simulated environment 140 may be communicatively coupled via a network 150. The client device 120 may be a processor-based device including, for example, an augmented reality (AR) or virtual reality (VR) device (e.g., a virtual reality headset), a smartphone, a tablet computer, a wearable apparatus, a virtual assistant, an Internet-of-Things (IoT) appliance, and/or the like. The network 150 may be a wired network and/or a wireless network including, for example, a wide area network (WAN), a local area network (LAN), a virtual local area network (VLAN), a public land mobile network (PLMN), the Internet, and/or the like.

In some example embodiments, the procurement gateway 110 may be configured to mediate the procurement of an asset 145 in the computer simulated environment 140. The asset 145 may be a digital asset that is native to the computer simulated environment. Alternatively and/or additionally, the asset 145 may be a physical asset that exists beyond the computer simulated environment 140. The procurement of the asset 145 may be subjected to one or more policies associated with the procurement application 135 hosted at the cloud platform 130. For example, applying a procurement policy 115 may impose, on the purchase of the asset 145, certain restrictions such as price, budget, currency, quantity, supplier, time, and/or the like.

In some example embodiments, the procurement gateway 110 may interface with an application associated with the computer simulated environment 140 (e.g., via an application programming interface (API) and/or the like) to share and synchronize relevant procurement policies such as the procurement policy 115. Furthermore, to increase the compatibility of procurement policies with the computer simulated environment 140 and improve user experience, the procurement gateway 110 may adapt, for example, the procurement policy 115, based on whether application of the procurement policy 115 in the computer simulated environment 140 results in an above- or below-threshold quantity of rejections. It should be appreciated that the procurement policy 115 may be specific to assets associated with the computer simulated environment 140. Alternatively, the procurement policy 115 may be applicable to assets associated with the computer simulated environment 145 as well as assets independent of the computer simulated environment 145. Nevertheless, the procurement policy 115 may be configured through interactions with the procurement application 135.

In some example embodiments, the procurement gateway 110 may enable the integration of the asset 145 available through the computer simulated environment 140 into the procurement application 135 such that procurement policies configured through the procurement application 135 may be enforced against purchases of the asset 145. For example, the asset 145 may be associated with a special tag identifying the asset 145 as such when the asset 145 appears, for example, as a part of a line item in a catalog or a classification system of the procurement application 135. Moreover, the procurement gateway 110 may respond to a procurement transaction conducted in the computer simulated environment 140 via, for example, the client device 120, by evaluating the procurement transaction against the relevant procurement policies in real time. Alternatively and/or additionally, the procurement gateway 110 may generate and export (e.g., via an application programming interface (API) and/or the like) a policy packet containing a set of procurement policies to the computer simulated environment 140 and/or the client device 120 interacting with the computer simulated environment 140. In this latter case, the computer simulated environment 140 and/or the client device 120 may perform a local assessment of whether the procurement transaction is consistent with the corresponding procurement policies.

To further illustrate, FIG. 1B depicts a schematic diagram illustrating the architecture of an example of the enterprise procurement system 100, in accordance with some example embodiments. As shown in FIG. 1B, one or more additional client devices 170 may interact with the procurement application 135 hosted at the cloud platform 130. For example, the one or more additional client devices 170 may be associated with sellers listing assets for sale via the procurement application 135 and/or buyers purchasing assets directly via the procurement application 135. In some cases, the one or more additional client devices 170 may be associated with administrative users who interacts with the procurement application 135 to configure the procurement policy 115.

Referring again to FIG. 1B, the procurement policy 115 may be applicable against the procurement transactions that include the asset 145 associated with the computer simulated environment 140. As noted, the asset 145 may be a digital asset that is native to the computer simulated environment 140 and/or a physical asset having a virtual representation within the computer simulated environment 140 but exists beyond the computer simulated environment 140. In some example embodiments, the asset 145 may be integrated into the procurement application 135, for example, by being defined as an asset associated with the computer simulated environment 140. In some cases, the asset 145 associated with a special tag when the asset 145 appears as a part of a line item in a catalog and/or classification system associated with the procurement application 135. Moreover, the purchase of the asset 145 may be subjected to the policy 115 when the client device 120 interacts with the computer simulated environment 140 to initiate a procurement transaction including the asset 145.

To further illustrate, Table 1 below depicts an example definition for the asset 145. As shown in Table 1, the definition for the asset 145 may include additional fields that are specific to the computer simulated environment 140.

TABLE 1
Item Id: 123456
ItemName: e.g. VirtualHelmet
Item Type: “MetaverseItem”
SecondaryMetaVerseDetail: { FullyVirtualAsset, VirtualToPhysicalAsset,
VirtualToService}
Payment Method: “CryptoCurrency”
AllowedCryptoCurrencies: { XRP, BTC, NFT...}
MetaverseDevices: { Oculus, Xbox, PlayStation, SmartPhone...}
MetaversePolicyPacket: { VRPolicyPacket, GamingPolicyPacket, RetailPacket}
MetaverseId: <if any specific id is present in the metaverse say it's a digital land or
digital asset id>

Table 2 below depicts an example definition for the policy 115. The policy 115 may include a set of keys and values (e.g., actions), which may be exportable (e.g., to the computer simulated environment 140 and/or the client device 120 interacting with the computer simulated environment 140) using an application programming interface (e.g., a representational state transfer (REST) based application programming interface (API)) and extensible markup language (XML).

```
TABLE 2
{
  PacketType: VRPolicyPacket
  PolicyPacketId: 9999
  PacketDevices: {Oculus, Samsung, Microsoft, HTC}
  ItemName: VirtualHelmet
  ItemId: 123456
  PolicyCount: 2
  Policies {
    {
    PolicyId: 9999-1
      Policy: Disallow Crypto // “this disallows the virtual helmet to
be bought using a crypto currency”
    }
    {
      PolicyId: 9999-2
    Policy: MustBe IndianSupplier // this allows only if a supplier
    address is in india
    }
  }
```

The procurement gateway 110 may enable the policy 115 to be enforced against the purchase of the asset 145 in the computer simulated environment 140 in a variety of ways. In some example embodiments, upon detecting (e.g., via an application programming interface (API) 155) the purchase transaction including the asset 145, the procurement gateway 110 may apply the policy 115 to evaluate compliance of the purchase transaction in real time. For example, the procurement gateway 110 may receive, from the client device 120 and/or the computer simulated environment 140, an application programming interface (API) call corresponding to the procurement transaction (e.g., buy_item(id=123456, action=“Buy”, currency=“BTC”, supplier=“Gopal Enterprises, India}). The procurement gateway 110 may apply the policy 115 and return, to the client device 120 and/or the computer simulated environment 140, a result of applying the policy 115. For instance, if the procurement transaction violates the policy 115, the procurement gateway 110 may return a message that indicates a rejection of the procurement transaction and the corresponding reason (e.g., {“Disallowed”, “Invalid currency chosen”}).

Alternatively and/or additionally, the procurement gateway 110 may share and synchronize the policy 115 with the computer simulated environment 140 and/or the device 120 interacting with the computer simulated environment 140. This configuration may be especially suitable if the asset 145 is purchased frequently. For example, as shown in FIG. 1B, the procurement gateway 110 may generate a packet 160 including the policy 115 (e.g., in an extensible markup language (XML) format) and share the packet 160 with the computer simulated environment 140 and/or the client device 120. In some example embodiments, the packet 160 may be specific to a particular type of client device interacting with the computer simulated environment 140 (e.g., an augmented reality (AR) or virtual reality (VR) device such as a virtual reality headset) and/or a certain category of asset from the computer simulated environment 140 (e.g., virtual helmets). Moreover, the packet 160 may contain a set of policies, including those that impose conditional checks (e.g., if x then y) and mandatory or optional check values. For instance, the policy 115 may be applied on procurement transactions exceeding a certain threshold value but not on those below the threshold value.

In some cases, a lightweight policy engine library may be shared along with the packet 160 such that compliance with the policy 115 may be determined remotely at the client device 120 and/or the computer simulated environment 140, with the results of the remote evaluation being returned to the procurement gateway 110 in batches and/or in real time. In scenario, the policy 115 may be cached at the client device 120 and/or the computer simulated environment 140, and be subjected to periodic updates from the procurement gate 110 in order to remain synchronized with changes made via the procurement application 135.

In some example embodiments, the procurement gateway 110 may be configured to adapt the policy 115 based on whether application of the policy 115 results in an above- or below-threshold quantity of rejections. For example, the procurement gateway 110 may maintain an audit log that includes the results of applying the policy 115 against various procurement transactions. Table 3 below depicts an example of an entry within the audit log.

TABLE 3
Logid:02223, ItemId: 123456, Action: Buy, Outcome: Disallow, Reason:
“Digital currency : BTC not allowed”

The procurement gateway 110 may, upon detecting an above-threshold quantity of rejections, apply a machine learning model trained to parse each rejected procurement transaction and identify one or more common attributes, similarities, or other patterns present amongst the rejected procurement transactions. For instance, the machine learning model may determine that the rejected procurement transactions generally requests the use of a cryptocurrency but the policy 115 forbids the use of cryptocurrencies. Accordingly, the procurement gateway 110 may generate a recommendation to modify the policy 115 to permit the use of cryptocurrency in order to increase the compatibility of procurement policies with the computer simulated environment 140 and improve user experience.

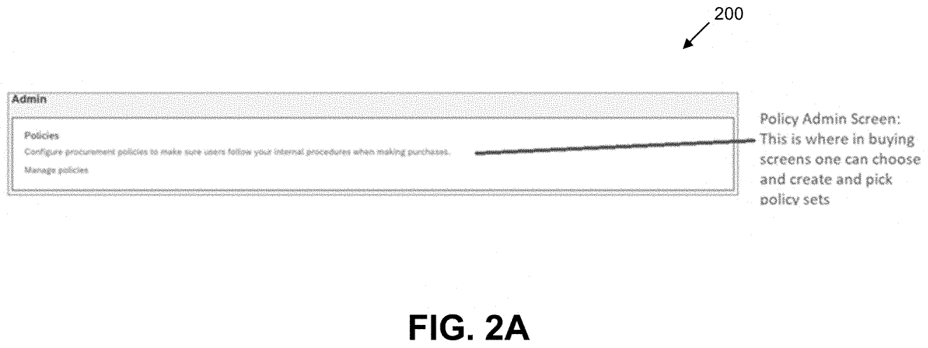

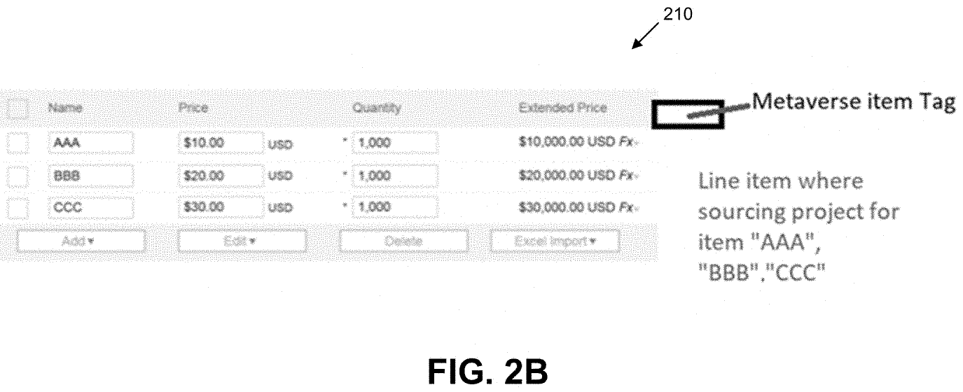

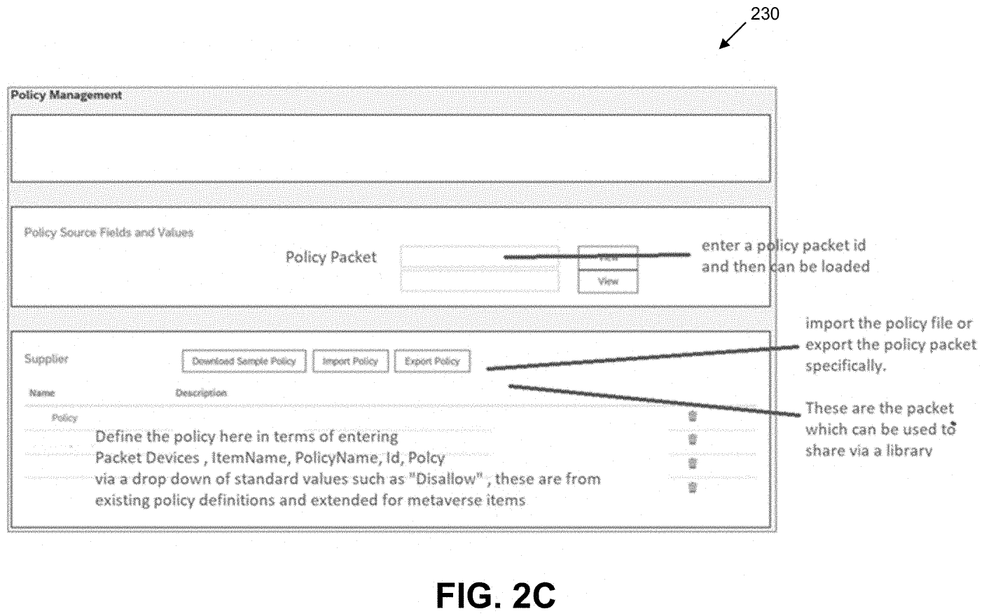

FIGS. 2A-C depict screenshots illustrating examples of various use interfaces associated with the procurement gateway 110, in accordance with some example embodiments. Referring first to FIG. 2A, the user interface 210 shown in FIG. 2A may be configured to enable the configuration of the policy 115, for example, via the procurement application 135. FIG. 2B depicts a user interface 220 displaying line items corresponding to assets associated with the computer simulated environment 140. As noted, assets associated with the computer simulated environment 140, such as the asset 145, may be associated with a special tag that identifies the assets as such when the assets are displayed as a part of a catalog and/or classification system associated with the procurement application 135.

FIG. 2C depicts an example of a user interface 230 for managing a procurement policy for assets from the computer simulated environment 140, in accordance with some example embodiments. As shown in FIG. 2C, the policy 115 applicable towards the procurement of the asset 145 in the computer simulated environment 140 may be defined based on one or more packet devices, an item name, a policy name, and a policy identifier. In some cases, the restrictions imposed by the policy 115 may be specified by selecting a value (e.g., actions such as “allow” or “disallow”) from a dropdown menu (or another user interface (UI) element) for each corresponding condition. Moreover, the policy 115 may be defined as a part of a packet for import and/or export.

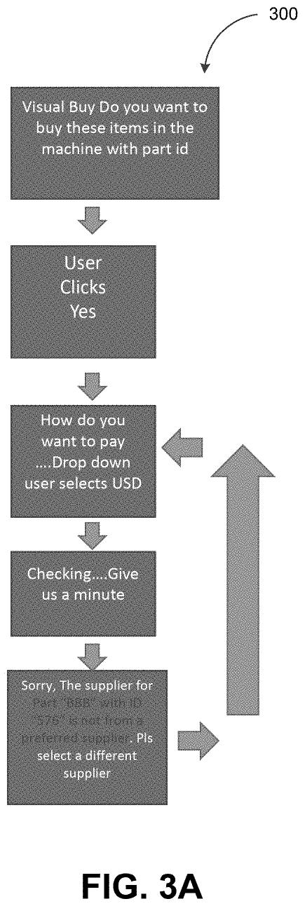

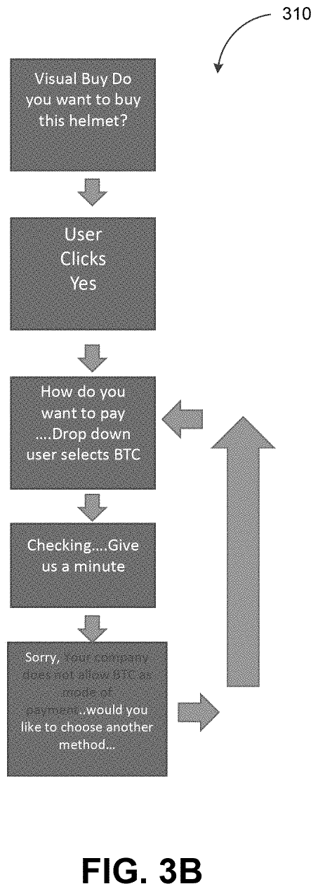

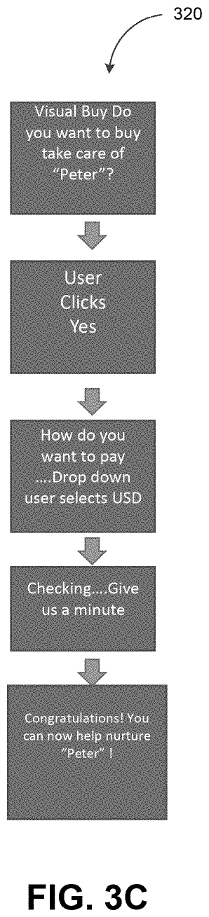

FIG. 3A depicts a flowchart illustrating an example of a process 300 for procuring assets from the computer simulated environment 140, in accordance with some example embodiments. Referring to FIG. 3A, in some cases, a single procurement transaction may include multiple assets from the computer simulated environment 140 (e.g., multiple parts for building a virtual machine). Accordingly, as shown in FIG. 3A, the client device 120 may receive one or more inputs for creating a procurement transaction having multiple assets from the computer simulated environment 140. That procurement transaction may be validated by applying one or more applicable procurement policies. For example, the procurement transaction may be validated at the procurement gateway 110, the client device 120, and/or the computer simulated environment 140. The validation of the procurement transaction may include determining whether one or more attributes of the procurement transaction are consistent with the restrictions imposed by the applicable procurement policies. For instance, the validation of the procurement transaction may include determining whether one or more of the price, budget, currency, quantity, supplier, and time of the procurement transaction are consistent with the restrictions imposed by the applicable procurement policies. In cases where the procurement transaction includes numerous assets (e.g., a batch of parts), the validation may be performed at the procurement gateway 110 whereas procurement transactions with fewer assets may be validated locally at the client device 120.

FIG. 3B depicts a flowchart illustrating another example of a process 310 for procuring assets from the computer simulated environment 140, in accordance with some example embodiments. FIG. 3B depicts an example in which the asset being purchased through the computer simulated environment 140 is a physical asset having a virtual representation within the computer simulated environment 140. Accordingly, a user at the client device 120 may interact with the virtual representation of the physical asset in order to generate a corresponding procurement transaction. However, as noted, an procurement transaction in the computer simulated environment 140 may also include digital assets that are entirely virtual and native to the computer simulated environment 140 such as non-fungible tokens (NFTs).

FIG. 3C depicts a flowchart illustrating another example of a process 300 for procuring assets from the computer simulated environment 140, in accordance with some example embodiments. FIG. 3C depicts an example in which the asset being purchased through the computer simulated environment 140 is a digital asset that is native to the computer simulated environment 140. In some cases, a single procurement transaction may include a combination of physical assets and fully digital assets. Nevertheless, the procurement gateway 110 may provide the applicable policies such that the procurement transaction can be validated at the procurement gateway 110, the client device 120, and/or the computer simulated environment 140. As noted, where the validation of the procurement transaction takes place may be determined based on the complexity of the procurement transaction. For example, more complex procurement transactions with a larger quantity of assets or a more diverse combination of assets may be evaluated at the procurement gateway 110 whereas less complex procurement transactions (e.g., those with relatively few assets) may be validated locally at the client device 120.

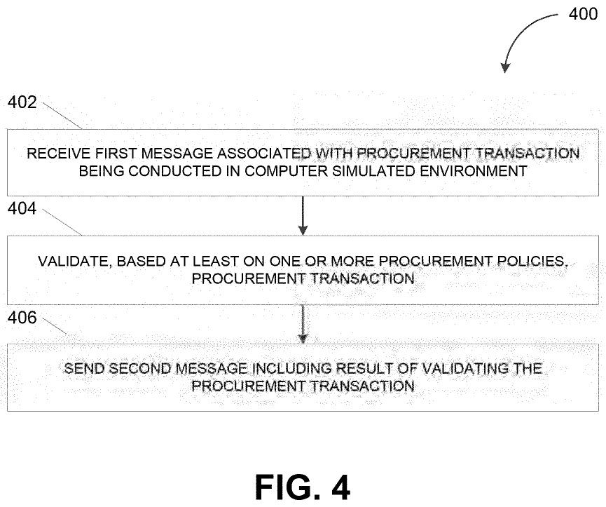

FIG. 4 depicts a flowchart illustrating an example of a process 400 for transaction validation in a computer simulated environment, in accordance with some example embodiments. Referring to FIG. 4, the process 400 may be performed by the procurement controller 110 in order to enable the enforcement of the policy 115 against, for example, a procurement transaction that includes the asset 145 in the computer simulated environment 140.

At 402, the procurement controller 110 may receive a first message associated with a procurement transaction being conducted in a computer simulated environment. In some example embodiments, the procurement controller 110 may interface with the computer simulated environment 140 (e.g., an application associated with the computer simulated environment 140) and/or the client device 120 interacting with the computer simulated environment 140 via an application programing interface (API). Accordingly, when the client device 120 interacts with the computer simulated environment 140 to initiate a procurement transaction that includes, for example, the asset 145, a corresponding application programming interface (API) call may be generated and sent to the procurement controller 110. The application programming call may include information that enables the procurement controller 110 to identify one or more applicable policies such as the policy 115. Examples of such information may include an item identifier, an action (e.g., buy or sell), and various action data (e.g., currency, supplier, and/or the like). In some cases, the applicable policies may be further identified based on the user associated with the procurement transaction including, for example, a role of the user, a department of the user, and/or the like.

At 404, the procurement controller 110 may validate, based at least on one or more procurement policies, the procurement transaction. In some example embodiments, the procurement controller 110 may apply, for example, the policy 115 in order to determine whether the procurement transaction including the asset 145 is compliant with the policy 115. For example, the validation of the procurement transaction including the asset 145 may include determining whether one or more of the price, budget, currency, quantity, supplier, and time of the procurement transaction are consistent with the restrictions imposed by the policy 115. The procurement transaction including the asset 145 may be rejected in the event the procurement transaction includes an inconsistent term such as a currency (e.g., cryptocurrency) that is not permitted by the policy 115. As noted, in some cases, the validation of the procurement transaction may be performed at the procurement controller 110. However, it is also possible for the validation of the procurement transaction to be performed the client device 120 and/or the computer simulated environment 140. In this latter case, the policy 115 may be cached at the client device 120 and/or the computer simulated environment 140. As noted, the policy 115 cached at the client device 120 and/or the computer simulated environment 140 may undergo periodic updates in order to remain synchronized with changes made via the procurement application 135.

At 406, the procurement controller 110 may send a second message including a result of validating the procurement transaction. For example, the procurement controller 110 may send, to the computer simulated environment 140 and/or the client device 120, a second message indicating whether the procurement transaction in the computer simulated environment 140 is rejected or allowed. Where application of the policy 115 results in a rejection of the procurement transaction including the asset 145, the second message may include a reason for the rejection (e.g., procurement transaction uses impermissible cryptocurrency). In some example embodiments, the procurement gateway 110 may maintain an audit log that includes the results of applying the policy 115 against various procurement transactions.

Where application of the policy 115 results in an above- or below-threshold quantity of procurement transactions being rejected, the procurement controller 110 may apply a machine learning model trained to parse each rejected procurement transaction and identify one or more common attributes, similarities, or other patterns present amongst the rejected procurement transactions. For example, the machine learning model may determine that the rejected procurement transactions generally requests the use of a cryptocurrency but the policy 115 forbids the use of cryptocurrencies. Accordingly, the procurement gateway 110 may generate a recommendation to modify the policy 115 to permit the use of cryptocurrency in order to increase the compatibility of procurement policies with the computer simulated environment 140 and improve user experience.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

Example 2: The system of Example 1, wherein the asset comprises a digital asset native to the computer simulated environment or a physical asset having a virtual representation within the computer simulated environment.

Example 3: The system of any one of Examples 1 to 2, wherein the operations further comprise: updating an audit log to include an entry corresponding to the result of validating the procurement transaction.

Example 4: The system of Example 3, wherein the operations further comprise: determining, based at least on the audit log, that application of a procurement policy results in an above- or below-threshold quantity of procurement transactions being rejected; applying a machine learning model trained to parse a plurality of procurement transactions rejected based on the procurement policy and identify at least one common attribute present in the plurality of procurement transactions; and generating a recommendation to modify the procurement policy based on the at least one common attribute.

Example 5: The system of any one of Examples 1 to 4, wherein the first message includes an identifier of the asset, an action, and data associated with the action, wherein the action comprises one of buy or sell, and wherein the data associated with the action includes at least one of a currency and a supplier.

Example 6: The system of any one of Examples 1 to 5, wherein the first message is generated in response to the client device interacting with the computer simulated environment to initiate the procurement transaction.

Example 7: The system of any one of Examples 1 to 6, wherein the first message and the second message each comprise an application programming interface (API) call.

Example 8: The system of any one of Examples 1 to 7, wherein the operations further comprise: sending, to the computer simulated environment and/or the client device, a packet including the one or more procurement policies such that another procurement transaction is validated at the computer simulated environment and/or the client device based on the one or more procurement policies cached at the computer simulated environment and/or the client device.

Example 9: The system of Example 8, wherein the operations further comprise: updating the one or more procurement policies cached at the computer simulated environment and/or the client device.

Example 10: The system of any one of Examples 1 to 9, wherein the client device comprises an augmented reality (AR) or virtual reality (VR) device.

Example 11: A computer-implemented method, comprising: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

Example 12: The method of Example 11, wherein the asset comprises a digital asset native to the computer simulated environment or a physical asset having a virtual representation within the computer simulated environment.

Example 13: The method of any one of Examples 11 to 12, further comprising: updating an audit log to include an entry corresponding to the result of validating the procurement transaction.

Example 14: The method of Example 13, further comprising: determining, based at least on the audit log, that application of a procurement policy results in an above- or below-threshold quantity of procurement transactions being rejected; applying a machine learning model trained to parse a plurality of procurement transactions rejected based on the procurement policy and identify at least one common attribute present in the plurality of procurement transactions; and generating a recommendation to modify the procurement policy based on the at least one common attribute.

Example 15: The method of any one of Examples 11 to 14, wherein the first message includes an identifier of the asset, an action, and data associated with the action, wherein the action comprises one of buy or sell, and wherein the data associated with the action includes at least one of a currency and a supplier.

Example 16: The method of any one of Examples 11 to 15, wherein the first message is generated in response to the client device interacting with the computer simulated environment to initiate the procurement transaction.

Example 17: The method of any one of Examples 11 to 16, wherein the first message and the second message each comprise an application programming interface (API) call.

Example 18: The method of any one of Examples 11 to 17, further comprising: sending, to the computer simulated environment and/or the client device, a packet including the one or more procurement policies such that another procurement transaction is validated at the computer simulated environment and/or the client device based on the one or more procurement policies cached at the computer simulated environment and/or the client device; and updating the one or more procurement policies cached at the computer simulated environment and/or the client device.

Example 19: The method of any one of Examples 11 to 18, wherein the client device comprises an augmented reality (AR) or virtual reality (VR) device.

Example 20: A non-transitory computer readable medium storing instructions, which when executed by at least one data processor, result in operations comprising: receiving, from a computer simulated environment and/or a client device interacting with the computer simulated environment, a first message associated with a procurement transaction being conducted in the computer simulated environment, the procurement transaction including an asset associated with the computer simulated environment; in response to receiving the first message, validating, based at least on one or more procurement policies, the procurement transaction; and sending, to the computer simulated environment and/or the client device interacting with the computer simulated environment, a second message including a result of validating the procurement transaction.

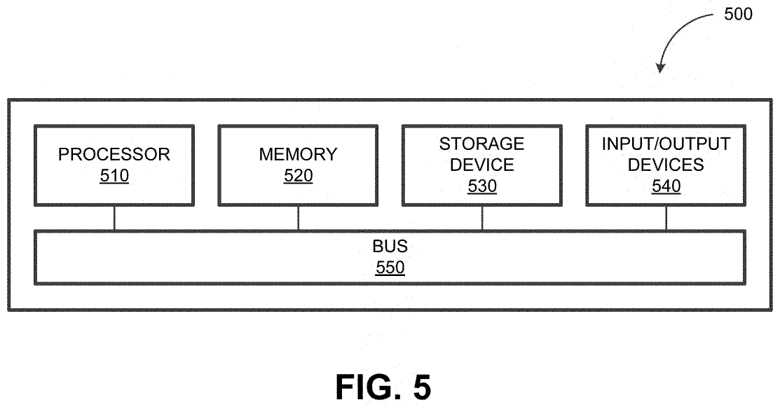

FIG. 5 depicts a block diagram illustrating a computing system 500, in accordance with some example embodiments. Referring to FIGS. 1-5, the computing system 500 can be used to implement the procurement gateway 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the procurement gateway 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one data processor; and
at least one memory storing instructions which, when executed by the at least one data processor, result in operations comprising:
receiving, by a gateway interfacing a software application, a first message from a computer simulated environment and/or a client device interacting with the computer simulated environment, the first message associated with a procurement transaction being conducted in the computer simulated environment, the procurement transaction including an asset associated with the computer simulated environment, wherein the asset comprises a digital asset native to the computer simulated environment or a physical asset having a virtual representation within the computer simulated environment;
in response to receiving the first message, validating, by the gateway and based at least on one or more procurement policies associated with the software application, the procurement transaction being conducted in the computer simulated environment; and
sending, by the gateway and to the computer simulated environment and/or the client device interacting with the computer simulated environment, a second message including a result of validating the procurement transaction;
updating, by the gateway, an audit log to include an entry corresponding to the result of validating the procurement transaction;
determining, by the gateway and based at least on the audit log, that the software application of the one or more procurement policies results in an above- or below-threshold quantity of procurement transactions being rejected;
applying, by the gateway, a machine learning model trained to parse a plurality of procurement transactions rejected based on the one or more procurement policies and to identify at least one common attribute present in the plurality of procurement transactions;
adapting, by the gateway, the one or more procurement policies using a recommendation to modify the one or more procurement policies, the recommendation generated by the gateway based on the at least one common attribute; and
updating, by the gateway, at least the software application with the modified one or more procurement policies to synchronize the gateway and the software application.

2. (canceled)

3. (canceled)

4. (canceled)

5. The system of claim 1, wherein the first message includes an identifier of the asset, an action, and data associated with the action, wherein the action comprises one of buy or sell, and wherein the data associated with the action includes at least one of a currency and a supplier.

6. The system of claim 1, wherein the first message is generated in response to the client device interacting with the computer simulated environment to initiate the procurement transaction.

7. The system of claim 1, wherein the first message and the second message each comprise an application programming interface (API) call.

8. The system of claim 1, wherein the operations further comprise:
sending, to the computer simulated environment and/or the client device, a packet including the one or more procurement policies such that another procurement transaction is validated at the computer simulated environment and/or the client device based on the one or more procurement policies cached at the computer simulated environment and/or the client device.

9. The system of claim 8, wherein the operations further comprise:
updating the one or more procurement policies cached at the computer simulated environment and/or the client device.

10. The system of claim 1, wherein the client device comprises an augmented reality (AR) or virtual reality (VR) device.

11. A computer-implemented method, comprising:
receiving, by a gateway interfacing a software application, a first message from a computer simulated environment and/or a client device interacting with the computer simulated environment, the first message associated with a procurement transaction being conducted in the computer simulated environment, the procurement transaction including an asset associated with the computer simulated environment, wherein the asset comprises a digital asset native to the computer simulated environment or a physical asset having a virtual representation within the computer simulated environment;
in response to receiving the first message, validating, by the gateway and based at least on one or more procurement policies associated with the software application, the procurement transaction being conducted in the computer simulated environment; and
sending, by the gateway and to the computer simulated environment and/or the client device interacting with the computer simulated environment, a second message including a result of validating the procurement transaction;
updating, by the gateway, an audit log to include an entry corresponding to the result of validating the procurement transaction;
determining, by the gateway and based at least on the audit log, that the software application of the one or more procurement policies results in an above- or below-threshold quantity of procurement transactions being rejected;
applying, by the gateway, a machine learning model trained to parse a plurality of procurement transactions rejected based on the one or more procurement policies and to identify at least one common attribute present in the plurality of procurement transactions;
adapting, by the gateway, the one or more procurement policies using a recommendation to modify the one or more procurement policies, the recommendation generated by the gateway based on the at least one common attribute; and
updating, by the gateway, at least the software application with the modified one or more procurement policies to synchronize the gateway and the software application.

12. (canceled)

13. (canceled)

14. (canceled)

15. The method of claim 11, wherein the first message includes an identifier of the asset, an action, and data associated with the action, wherein the action comprises one of buy or sell, and wherein the data associated with the action includes at least one of a currency and a supplier.

16. The method of claim 11, wherein the first message is generated in response to the client device interacting with the computer simulated environment to initiate the procurement transaction.

17. The method of claim 11, wherein the first message and the second message each comprise an application programming interface (API) call.

18. The method of claim 11, further comprising:
sending, to the computer simulated environment and/or the client device, a packet including the one or more procurement policies such that another procurement transaction is validated at the computer simulated environment and/or the client device based on the one or more procurement policies cached at the computer simulated environment and/or the client device; and
updating the one or more procurement policies cached at the computer simulated environment and/or the client device.

19. The method of claim 11, wherein the client device comprises an augmented reality (AR) or virtual reality (VR) device.

20. A non-transitory computer readable medium storing instructions, which when executed by at least one data processor, result in operations comprising:
receiving, by a gateway interfacing a software application, a first message from a computer simulated environment and/or a client device interacting with the computer simulated environment, the first message associated with a procurement transaction being conducted in the computer simulated environment, the procurement transaction including an asset associated with the computer simulated environment, wherein the asset comprises a digital asset native to the computer simulated environment or a physical asset having a virtual representation within the computer simulated environment;
in response to receiving the first message, validating, by the gateway and based at least on one or more procurement policies associated with the software application, the procurement transaction being conducted in the computer simulated environment; and
sending, by the gateway and to the computer simulated environment and/or the client device interacting with the computer simulated environment, a second message including a result of validating the procurement transaction;
updating, by the gateway, an audit log to include an entry corresponding to the result of validating the procurement transaction;
determining, by the gateway and based at least on the audit log, that the software application of the one or more procurement policies results in an above- or below-threshold quantity of procurement transactions being rejected;
applying, by the gateway, a machine learning model trained to parse a plurality of procurement transactions rejected based on the one or more procurement policies and to identify at least one common attribute present in the plurality of procurement transactions;
adapting, by the gateway, the one or more procurement policies using a recommendation to modify the one or more procurement policies, the recommendation generated by the gateway based on the at least one common attribute; and
updating, by the gateway, at least the software application with the modified one or more procurement policies to synchronize the gateway and the software application.
